(19) United States
(12) Patent Application Publication
(10) Pub. No.: US 2017/0063789 A1
(43) Pub. Date: Mar. 2, 2017

(54) OptiArmor Secure Separation Device

(71) Applicant: SRC, Inc., North Syracuse, NY (US)

(72) Inventors: James M. Marcinkowski, Boonville, NY (US); Anthony G. Casale, Ilion, NY (US); Michael J. Seakan, Clinton, NY (US); Mark W. Webb, Whitesboro, NY (US); Robert A. Marceau, Deansboro, NY (US)

(73) Assignee: SRC, INC., North Syracuse, NY (US)

(21) Appl. No.: 14/816,167

(22) Filed: Aug. 3, 2015

Related U.S. Application Data
(60) Provisional application No. 62/032,222, filed on Aug. 1, 2014.

(51) Int. Cl. H04L 29/06; H04L 9/32; H04L 9/30; H04L 9/00

(52) U.S. Cl. CPC H04L 63/0245; H04L 63/105; H04L 9/006; H04L 9/3263; H04L 9/30

(57) ABSTRACT

A method for secured separation within a computer network. The method includes the step of: (i) providing a secure separation module between a low security computer network and a high security computer network; (ii) intercepting, by the secure separation module, any data directed from the low security computer network to the high security computer network; (iii) routing, by the secure separation module, the data to a first destination; (iv) authenticating the communication; (v) filtering the data using one or more filters; and (vi) communicating the data, only if it passes the one or more filters, to a destination computer network.

### CROSS-REFERENCE TO RELATED APPLICATIONS

This application claims priority to U.S. Provisional Patent Application Ser. No. 62/032,222, filed on Aug. 1, 2014 and entitled “OptiArmor Secure Separation Device,” the entire disclosure of which is incorporated herein by reference.

### FIELD OF THE INVENTION

The present invention is directed to methods and systems for providing secure communications to and from a high security computer network.

### BACKGROUND

Protection of computer networks from unintended data disclosure by unauthorized access or interception has been a concern of the computer and network industries for decades. Although systems such as firewalls, anti-virus and -spyware software, and other types of monitoring provide a layer of protection, new methods of cyberattack are continually being developed and tested. New brute force attacks, viruses, phishing scams, and many other types of intrusions are launched every day throughout the world. Accordingly, existing security software, methods, and devices do not provide sufficient protection from unwanted outside access. This is particularly true for computer networks that require especially high levels of security, such as government and business. Indeed, the greater the need for security for data, the greater the likelihood that the data will be a target.

One method of providing additional security is to separate components in a system or between systems, and to control the flow of information between the separated systems. Several separation mechanisms are currently employed to ensure data separation, including separate physical components and separation kernels, among others. The separated system then only allows authorized information to flow between components, or authorized communications based on security checks such as access control guards, cryptography, and others.

Despite these existing separation mechanisms, there is a continued need for innovative approaches for secure separation of components within critical infrastructure systems. Indeed, over half of critical infrastructure providers have reported attacks on their networks and threats from malicious actors both internal and external to their organization. Further, these attacks can result in disruption to essential services, extensive remediation expenses, and a long-term negative impact on reputation. For providers of critical infrastructure services, the need to protect their assets while securely exchanging a wide variety of data across internal and external information channels is paramount to their daily operations and their customer base. Currently, cross domain solutions typically utilize basic constructs to secure the flow of information across different security domains. Further, commercial separation products do not provide, for example, sufficient protocol-specific parsing, validation, filtering, and/or cross-message signature filtering.

Accordingly, there is a continued need for methods and systems that can provide robust and secure separation between mission critical components of an infrastructure system in a cost-efficient manner.

### SUMMARY OF THE INVENTION

The present disclosure is directed to inventive methods and systems for secured separation within computer network communications. Communications from a lower-security network are sent to a Secure Separation Device or Component where they are authorized and/or processed before being transmitted to a higher-security network. Since communications can be bi-directional across the Secure Separation Device or Component, the bi-directional validation of that data is important to detect maliciously (insider threat) or accidentally generated improper communications from the higher-security network. Processing of the communications includes, for example, content inspection; filtering based on content, the number of messages transmitted, the current state of system components, and other aspects; and sender/receiver authentication, among many others.

According to an aspect, a method for secured separation within a computer network is provided. The method includes the step of: (i) providing a secure separation module between a low security computer network and a high security computer network; (ii) intercepting, by the secure separation module, any data directed from the low security computer network to the high security computer network and vice versa; (iii) routing, by the secure separation module, the data to a first destination process; (iv) authenticating the communication; (v) filtering the data using one or more filters; and (vi) communicating the data, only if it passes the one or more filters, to the destination computer network.

According to an embodiment, the method includes the step of intercepting, by the secure separation module, any data directed from the high security computer network to the low security computer network.

According to an embodiment, the system is implemented within an electrical utility system.

According to an embodiment, the security of the high security computer network is greater than the security of the low security computer network. According to another embodiment, the low security computer network is an external computer network, and further wherein the high security computer network is an internal computer network.

According to an embodiment, the communication is a wireless communication.

According to an embodiment, the method includes the step of decrypting the communication.

According to an aspect, a method for secured separation within a computer network is provided. The method includes the steps of: (i) providing a secure separation system comprising: a first secure separation module between a low security computer network and a first high security computer network, and a second secure separation module between the low security computer network and a second high security computer network; (ii) intercepting, by the secure separation module, any data directed from the low security computer network to the first or second high security computer network; (iii) routing, by the first or second secure separation module, the data to a first destination; (iv) authenticating the communication; (v) filtering the data using one or more filters; and (vi) communicating the data, only if it passes the one or more filters, to a destination computer network.

According to an aspect, a system providing method for secured separation within a computer network. The system includes: (i) a low security computer network; (ii) a high security network; and (iii) a secure separation module positioned between the low security computer network and the high security computer network, where the secure separation module is configured to: intercept any data directed from the low security computer network to the high security computer network and vice versa; authenticate the communication; filter the data using one or more filters; and communicate the data, only if it passes the one or more filters, to the destination computer network.

According to an embodiment, the system further includes a second secure separation module between the low security computer network and a second high security computer network.

These and other aspects of the invention will become clear in the detailed description set forth below.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1A is a schematic representation of a computer network system, in accordance with an embodiment.

FIG. 1B is a schematic representation of a computer network system with secured separation, in accordance with an embodiment.

FIG. 2 is a schematic representation of a secured separation system for computer network communications, in accordance with an embodiment

FIG. 3 is a schematic representation of a secured separation system for computer network communications, in accordance with an embodiment.

### DETAILED DESCRIPTION OF EMBODIMENTS

The present disclosure is directed to embodiments of a method and system for providing secure separation of components, systems, and/or sub-systems within a computer network. For example, communications from a lower-security network are sent to a Secure Separation Device or Component where they are authorized and/or processed before being transmitted to a higher-security network. Communications can be bi-directional across the Secure Separation Device or Component. Processing of the communications includes, for example, content inspection; filtering based on content, the number of messages transmitted, the current state of system components, and other aspects; and sender/receiver authentication, among many others.

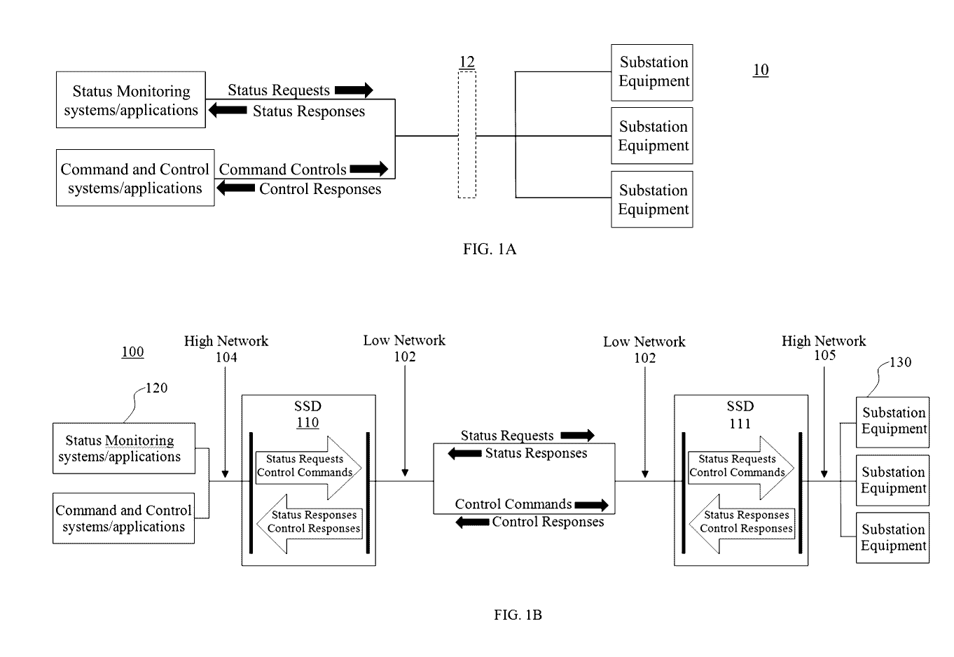

Referring to FIG. 1A, in one embodiment, is a system 10. The figure depicts a particular application of the invention, specifically validation of the communications within a Supervisory Control and Data Acquisition (“SCADA”) electrical utility system. The Status Monitoring and Command/Control applications reside on a High Security Network (called the Master Domain) within the Command Center. A multitude of sensors and devices communicate with each other over another High Security Network, within the remote Substation (called the Slave Domain). The Master Domain and the Slave Domain are connected via a Low Security Network, such as the Internet. According to an embodiment, data such as status requests and command controls are sent from one portion, aspect, or component of the system, and are communicated to another portion, aspect, or component of the system such as the Substation Equipment depicted, without separation. System 10 may optionally comprise a firewall 12, a security protocol or software such as anti-virus scanning or monitoring, or a digital certificate or other public key infrastructure (“PKI”) system or mechanism. System 10 may also comprise one or more Secure Separation Devices (“SSD”), which are described in detail below.

Referring to FIG. 1B, in one embodiment, is a secure computer network system 100 that utilizes separation of components to ensure security of the system. FIG. 1B depicts both the Master and Slave Domain High Security Networks protected by SSDs. While either of these SSDs may be considered optional, this implementation affords the best security against a bi-directional ‘man in the middle’ attack; which is a malicious attack on the Low Security Network that allows the inspection, simulation and mutilation of data streams as they pass.

According to an embodiment, data such as status requests and control commands are sent from one portion, aspect, or component 120 of the system, and are communicated over a High Security Network to the Secure Separation Device (“SSD”) component 110. Notably, “high” and “low” typically, but not always, refer to a comparison between a lower-security communication network and a higher-security communication network. However, in some embodiments the low and high networks may have the same approximate security level. In other embodiments, “low” may refer to “external” communications or communications the security for which is not directly controlled by an organization, while “high” may refer to “internal” communications or communications the security for which are directly controlled by the organization. Filtering of the outgoing status requests and control commands can immediately detect/block malicious (insider threat) or accidental command streams. Validated/approved communications are routed to the SSD component 111 via a Low Network 102, meaning that the network 102 is a lower security level network. The communication is received and then authorized and/or processed by the SSD 111, and the authorized/processed communication is communicated to separated components 130 via a High Network 105, meaning that the network 105 is a higher security level network.

Communication can occur in the opposite direction as well. Outgoing communications such as status responses and command controls are sent from one portion, aspect, or component 130 of the system, and are communicated to the SSD 111 by high network 105. The communication is received and then authorized and/or processed by the SSD 111, and the authorized/processed communication is communicated to SSD 110 via the low network. The SSD on the component 120 end of the Low Network 102 protects the Command Center component 120 from malicious or malformed responses, in the same manner that SSD 111 protected the Substation Equipment. The two SSDs work in tandem to detect/prevent bi-directional ‘man in the middle’ attacks.

Although FIG. 1B depicts status requests/responses and control commands/responses being communicated in system 100, the communication can comprise any data that can be communicated. For example, the data communicated across the SSD might be any commands, requests, emails, video, audio, attachments, or other types of communications. According to an embodiment, the communications in FIG. 1B can be wired or wireless. For example, especially within the low network 102, communications may be by wired connections, wireless connections, and/or a combination of wired and wireless communications, including but not limited to WiFi, BlueTooth, and a variety of other wireless communications methods.

According to an embodiment, the SSD described or otherwise envisioned herein provides high-assurance separation between components, thereby offering critical protection of infrastructure elements and mission essential data flows. With the ability to ensure information is exchanged only between authenticated entities, the SSD instantiates mutually authenticated trusted pipelines using cryptographic standards. According to an embodiment, the SSD is an easily installed software or hardware component. Once installed, the SSD can effectuate and enforce high-speed, bi-directional, multi-channel data inspection, validation, and filtering at various levels of abstraction in accordance with organizationally-defined highly-adaptable security policies.

According to an embodiment, the SSD comprises content-aware routing capabilities. For example, the SSD may comprise one or all of the following: (i) firewall/router capabilities, which for example can be provided by Linux IP Tables; (ii) separated process flows used to separate difference directions and different message type (command filtering, source/destination filtering, and/or OID filtering); (iii) deep content inspection performed within each flow allows for finer grained routing decisions; (iv) modular filtering/routing architecture to support dynamic/distributed filter integration depending on data types processed; and/or (v) multi-level security policies. The SSD can also comprise, for example, PKI protocols and components for identification and authentication of data/communications. Accordingly, the SSD offers encrypted, unidirectional, securely separated pipelines for receiving, inspecting, validating, encapsulating and delivering data.

According to an embodiment, the SSD can be accessed as a service and can feature an optional API, allowing the system to be interfaced to existing network topologies and IT infrastructures without requiring on-the-site installation of additional hardware. Various other components and features, according to embodiments, include a labeled multi-level secure architecture; continually verified code base/configuration; secure protocol break between input and output interfaces; deep content inspection for on-the-fly protocol/data content disassembly, validation, and reassembly; strong sender/receiver authentication and data-in-transit/data-at-rest protection through digital certificate signing and encryption, among other embodiments.

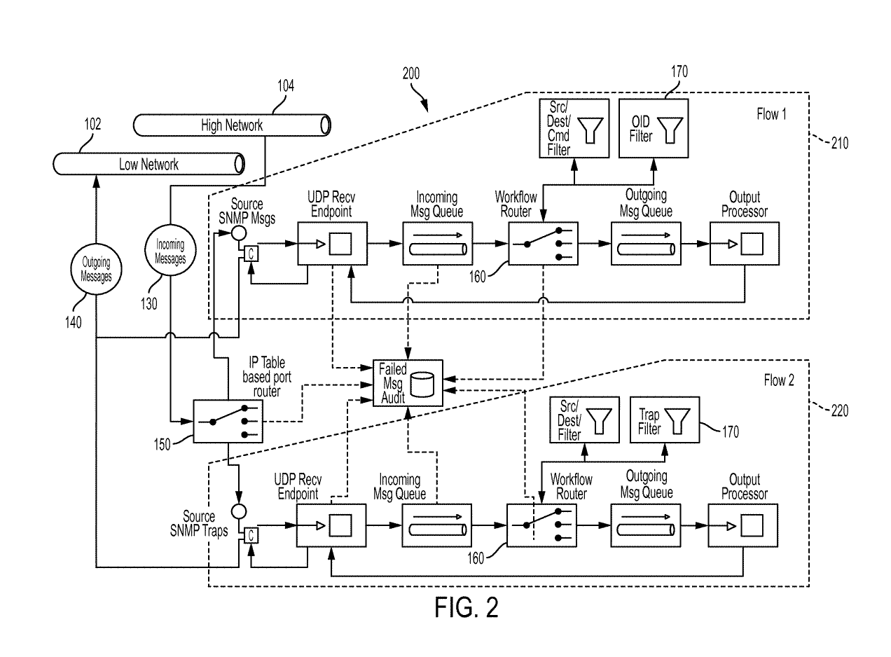

Referring to FIG. 2, in one embodiment, is example of an architecture for an SSD system 200, showing flow of messages from components located within or beyond a higher security network 104 to a lower security network 102. FIG. 2 depicts two different possible flows, from among many different possible flows, including Flow 1 labeled 210 and Flow 2 labeled 220. In this example, SNMP Get/Set messages are directed to Flow 1 (210) and SNMP Trap messages are processed in Flow 2 (220). For example, as shown in FIG. 2, the Simple Network Management Protocol (SNMP) over a UDP transmission is depicted to show the extensibility of the invention. While the SCADA example would employ a strict validation of Distributed Network Protocol 3 (DNP3) messages, simply adding the appropriate endpoint and filter modules to the SSD framework affords the same level of protection to other communication protocols.

According to an embodiment, an “incoming message” 130 represents data received from the higher security network 104 to the SSD, which is filtered and processed to become an “outgoing message 140” transmitted from the SSD 110 to the lower security network 102. Incoming message 130 is received by the SSD, and a router 150 changes the destination address and/or port of the incoming message to reach the proper host within the high security network. This port forwarding or mapping allows public machines, semi-public machines, or machines on a different network or system regardless of the level of security, to communicate with one or more machines within the private, higher security network. According to an embodiment, the router 150 can utilize IP tables to queue and direct incoming messages. The one or more IP routing rules store information about how the various networks within the high-security network can be reached, either direct or indirectly. In the first flow 210, the message can be properly routed by router 150 to the appropriate SNMP, UDP, and/or incoming message queue, among other possible components or steps. For example, as shown in FIG. 2, the router 150 may direct the message to a first flow 210 or a second flow 220, depending on the IP tables and the message itself.

According to an embodiment, a workflow router 160 directs the data to one or more filters 170 to analyze and/or process the message. The filters can be one or more of a number of protocol-specific filter types, and can be customized or programmed depending on the system, the incoming messages, organization, or a wide variety of other parameters. An important responsibility of the SSD is to inspect and confirm proper message format and content, as dictated by the protocol specification. This requires a combination of protocol-specific filters; an example of which is a value in range filter, which verifies that values in one or more specific fields in the data, communication, or message is within a predetermined value-based range. Another example of a filter is a message count filter, which counts the total number of messages of a specific type sent to a specific destination or endpoint. Yet another type of filter is a single end point sequence/signature filter, which verifies that a series of messages sent to a specific destination or endpoint do not match a certain predetermined sequence or signature, optionally also within a specific time period. Another type of filter is a multi-endpoint sequence/signature filter, which verifies that a series of messages sent to a group of destinations or endpoints does not match a certain predetermined sequence or signature, optionally within a specific or predetermined time period. Many other filters are possible. The message may be processed by all of the possible filters, or may be processed by a subset of the filters, where the particular subset can be random, or can be based on a parameter or value or other aspect of the data, communication, or message. For example, the length of the message may trigger a particular subset of filters within the possible universe of filters associated with the SSD. The end result of the filtering chain is that each and every bit and byte of the message has been inspected and validated against the protocol specification and any custom rule sets that the protected system requires. A message that fails validation will be logged and, optionally, blocked from further transmission.

According to an embodiment, before, after, or during filtering the sender and/or the data itself can be authorized by the SSD 110. For example, the authorization can involve a digital certificate or PKI, among other options. With proper configuration and authorization, the SSD can use supplied certificates and/or session keys to authenticate data sources/destinations and/or encrypted message data.

At several points along a work flow, a message can be rejected. This can be based on a wide variety of factors, including but not limited failure of a filtering test or any other type of analysis or test. The rejected message can be sent to a database of messages that have been rejected or otherwise failed quality control or filtering, among other options. The database itself may be utilized as a component of filtering. The rejected messages may be isolated or stored outside the higher security system to ensure security.

If the message passes the filters, it can be processed by an outgoing message queue, and then sent to an output processor. The outgoing message queue can schedule or otherwise prepare, order, or organize the message sending, and output processor can package or otherwise prepare the message for sending. The message then becomes an outgoing message 140 which is communicated from the SSD to the lower security network 102.

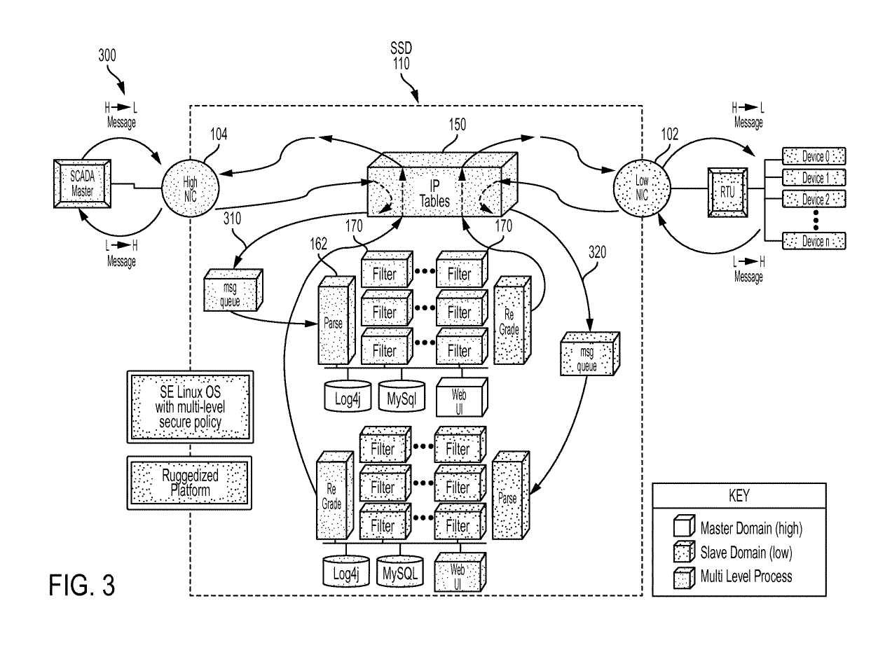

Referring to FIG. 3, in one embodiment, is another example of an architecture for an SSD system 300, showing the flow of messages from a lower security 102 network to a higher security network 104, and vice versa. It shows the message flows between the Master and Slave Domains as they are processed by the SSD and highlights the complete separation of that processing until the message data has been approved for delivery to the destination network. A secure operating system, such as SE Linux, provides the mandatory and discretionary (MAC/DAC) controls that allow this separation of data processing, while also securing the integrity of all SSD application code, data bases, log archives and system configuration files.

FIG. 3 depicts two different possible flows, first flow 310 and second flow 320. According to this embodiment, the secure separation device/system consists of one or more software modules running on a SE Linux operating system on an industrially hardened platform. For example, the software modules can include IP Tables based message receipt and queuing, a protocol specific (e.g., DNP3) parser, a collection of filters assembled via an Apache Camel based framework to make modular and reconfigurable architecture which relies largely on open source software to include Linux, Apache Camel, Jango, etc. The secure separation device, method, and system utilizes a filtering framework that is being developed to allow selection, configuration, and application of various filters to the message data being processed and in the specific filters themselves which guard against improper configuration and operation of electrical substation components to include device endpoints such as circuit breakers, relays/switches, and transformers. As noted above, a message can be rejected if, for example, it fails to pass a filter or is otherwise identified as non-secure.

According to an embodiment, a message, command, communication, or other data is sent from one network to the other via the SSD 110. Messages from either low network 102 or high network 104 are processed by router 150, which can use IP tables to queue and direct the incoming data. The one or more IP routing rules store information about how the various networks within the high-security network can be reached, either direct or indirectly. The router 150 can also be utilized to queue and/or direct the outgoing data, as shown by the flow of data represented by arrows in FIG. 3. The router 150 then directs the data/message to a message queue, where it is then parsed by a parser 162 and filtered by one or more filters 170. The filters can be any of the filters described or otherwise envisioned herein. If the data survives the filters, it is once again parsed/reassembled and sent back to the router 150 with instructions to be communicated to the other network. In other words, if the message or data came from the low security network and was bound for the high security network, the router 150 will use the IP tables to determine where to send the filtered and approved data or message.

Optionally, the SSD 110 may include a user interface that allows a user to configure, monitor, and/or modify one or more components of the SSD. For example, the user interface, which may be a web interface, a hardwired interface, or other interface, can display information about data processing, filters, communications, or any of a wide variety of other parameters.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

A “module” or “component” as may be used herein, can include, among other things, the identification of specific functionality represented by specific computer software code of a software program. A software program may contain code representing one or more modules, and the code representing a particular module can be represented by consecutive or non-consecutive lines of code.

As will be appreciated by one skilled in the art, aspects of the present invention may be embodied/implemented as a computer system, method or computer program product. The computer program product can have a computer processor or neural network, for example, that carries out the instructions of a computer program. Accordingly, aspects of the present invention may take the form of an entirely hardware embodiment, an entirely software embodiment, and entirely firmware embodiment, or an embodiment combining software/firmware and hardware aspects that may all generally be referred to herein as a “circuit,” “module,” “system,” or an “engine.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

The program code may perform entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowcharts/block diagrams in the Figures illustrate the architecture, functionality, and operation of possible implementations of systems, methods, and computer program products according to various embodiments of the present invention. In this regard, each block in the flowcharts/block diagrams may represent a module, segment, or portion of code, which comprises instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for secured separation within a computer network, the method comprising the steps of:
providing a secure separation module between a low security computer network and a high security computer network;
intercepting, by the secure separation module, any data directed from the low security computer network to the high security computer network;
routing, by the secure separation module, the data to a first destination;
authenticating the communication;
filtering the data using one or more filters; and
communicating the data, only if it passes the one or more filters, to a destination computer network.

2. The method of claim 1, further comprising the step of intercepting, by the secure separation module, any data directed from the high security computer network to the low security computer network.

3. The method of claim 1, wherein said system is implemented within an electrical utility system.

4. The method of claim 1, wherein the security of the high security computer network is greater than the security of the low security computer network.

5. The method of claim 1, wherein the low security computer network is an external computer network, and further wherein the high security computer network is an internal computer network.

6. The method of claim 1, wherein the communication is a wireless communication.

7. The method of claim 1, further comprising the step of decrypting the communication.

8. A method for secured separation within a computer network, the method comprising the steps of:
providing a secure separation system comprising: a first secure separation module between a low security computer network and a first high security computer network, and a second secure separation module between the low security computer network and a second high security computer network;
intercepting, by the secure separation module, any data directed from the low security computer network to the first or second high security computer network;
routing, by the first or second secure separation module, the data to a first destination;
authenticating the communication;
filtering the data using one or more filters; and
communicating the data, only if it passes the one or more filters, to a destination computer network.

9. The method of claim 8, further comprising the step of intercepting, by the secure separation module, any data directed from the high security computer network to the low security computer network.

10. The method of claim 8, wherein said system is implemented within an electrical utility system.

11. The method of claim 8, wherein the security of the first or second high security computer network is greater than the security of the low security computer network.

12. The method of claim 8, wherein the low security computer network is an external computer network, and further wherein the first and second high security computer networks are internal computer networks.

13. The method of claim 8, wherein the communication is a wireless communication.

14. A system for separation within a computer network, the system comprising:
a low security computer network;
a high security network;
a secure separation module positioned between the low security computer network and the high security computer network, wherein the secure separation module is configured to: (i) intercept any data directed from the low security computer network to the high security computer network; (ii) authenticate the communication; (iii) filter the data using one or more filters; and (iv) communicate the data, only if it passes the one or more filters, to a destination computer network.

15. The system of claim 14, wherein said system is implemented within an electrical utility system.

16. The system of claim 14, wherein the security of the high security computer network is greater than the security of the low security computer network.

17. The system of claim 14, wherein the low security computer network is an external computer network, and further wherein the high security computer network is an internal computer network.

18. The system of claim 14, further comprising a second secure separation module between the low security computer network and a second high security computer network.

19. The system of claim 14, wherein the communication is a wireless communication.

20. The system of claim 14, wherein the secure separation module is further configured to intercept any data directed from the high security computer network to the low security computer network.
